(19) United States
(12) Patent Application Publication
(10) Pub. No.: US 2011/0278006 A1
(43) Pub. Date: Nov. 17, 2011

(54) DEFLUIDIZING LOST CIRCULATION PILLS

(75) Inventors: Mark W. Sanders, Aberdeen (GB); Jason T. Scorsone, Houston, TX (US); Arvind D. Patel, Sugar Land, TX (US)

(73) Assignee: M-I L.L.C., Houston, TX (US)

(21) Appl. No.: 13/146,750

(22) PCT Filed: Jan. 29, 2010
(86) PCT No.: PCT/US10/22535

§ 371 Date: Jul. 28, 2011

Related U.S. Application Data
(62) Division of application No. 61/148,712, filed on Jan. 30, 2009.
Application No. 61/148,712 is a division of application No. 61/218,010, filed on Jun. 17, 2009.

(51) Int. Cl. E21B 33/13; C09K 8/58; E21B 33/138

(52) U.S. Cl. 166/293; 166/292; 507/269; 507/214; 507/219; 507/224; 507/221; 507/230

(57) ABSTRACT

A slurry for treating a wellbore that includes a base fluid; at least one fibrous structure; and a plurality of calcium silicate particles is disclosed. Methods of reducing loss of wellbore fluid in a wellbore to a formation using an LCM pill having calcium silicate particles therein is also disclosed.

### CROSS-REFERENCE TO RELATED APPLICATIONS

This applications claims priority under 35 U.S.C. §119(e) to U.S. Patent Application Nos. 61/148,712, filed on Jan. 30, 2009, and 61/218,010, filed on Jun. 17, 2009, both of which are hereby incorporated by reference in their entirety.

### BACKGROUND OF INVENTION

1. Field of the Invention

Embodiments disclosed herein relate generally to methods and compositions for lost circulation pills.

2. Background Art

During the drilling of a wellbore, various fluids are typically used in the well for a variety of functions. The fluids may be circulated through a drill pipe and drill bit into the wellbore, and then may subsequently flow upward through the wellbore to the surface. During this circulation, the drilling fluid may act to remove drill cuttings from the bottom of the hole to the surface, to suspend cuttings and weighting material when circulation is interrupted, to control subsurface pressures, to maintain the integrity of the wellbore until the well section is cased and cemented, to isolate the fluids from the formation by providing sufficient hydrostatic pressure to prevent the ingress of formation fluids into the wellbore, to cool and lubricate the drill string and bit, and/or to maximize penetration rate.

Wellbore fluids may also be used to provide sufficient hydrostatic pressure in the well to prevent the influx and efflux of formation fluids and wellbore fluids, respectively. When the pore pressure (the pressure in the formation pore space provided by the formation fluids) exceeds the pressure in the open wellbore, the formation fluids tend to flow from the formation into the open wellbore. Therefore, the pressure in the open wellbore is typically maintained at a higher pressure than the pore pressure. While it is highly advantageous to maintain the wellbore pressures above the pore pressure, on the other hand, if the pressure exerted by the wellbore fluids exceeds the fracture resistance of the formation, a formation fracture and thus induced mud losses may occur. Further, with a formation fracture, when the wellbore fluid in the annulus flows into the fracture, the loss of wellbore fluid may cause the hydrostatic pressure in the wellbore to decrease, which may in turn also allow formation fluids to enter the wellbore. As a result, the formation fracture pressure typically defines an upper limit for allowable wellbore pressure in an open wellbore while the pore pressure defines a lower limit. Therefore, a major constraint on well design and selection of drilling fluids is the balance between varying pore pressures and formation fracture pressures or fracture gradients though the depth of the well.

As stated above, wellbore fluids are circulated downhole to remove rock, as well as deliver agents to combat the variety of issues described above. Fluid compositions may be water- or oil-based and may comprise weighting agents, surfactants, proppants, viscosifiers, fluid loss additives, and polymers. However, for a wellbore fluid to perform all of its functions and allow wellbore operations to continue, the fluid must stay in the borehole. Frequently, undesirable formation conditions are encountered in which substantial amounts or, in some cases, practically all of the wellbore fluid may be lost to the formation. For example, wellbore fluid can leave the borehole through large or small fissures or fractures in the formation or through a highly porous rock matrix surrounding the borehole.

Lost circulation is a recurring drilling problem, characterized by loss of drilling mud into downhole formations. However, other fluids, besides “drilling fluid” can potentially be lost, including completion, drill-in, production fluid, etc. Lost circulation can occur naturally in formations that are fractured, highly permeable, porous, cavernous, or vugular. These earth formations can include shale, sands, gravel, shell beds, reef deposits, limestone, dolomite, and chalk, among others.

Lost circulation may also result from induced pressure during drilling. Specifically, induced mud losses may occur when the mud weight, required for well control and to maintain a stable wellbore, exceeds the fracture resistance of the formations. A particularly challenging situation arises in depleted reservoirs, in which the drop in pore pressure effectively weakens a wellbore through permeable, potentially hydrocarbon-bearing rock formation, but neighboring or inter-bedded low permeability rocks, such as shales, maintain their pore pressure. This can make the drilling of certain depleted zones impossible because the mud weight required to support the shale exceeds the fracture resistance of the sands and silts. Another unintentional method by which lost circulation can result is through the inability to remove low and high gravity solids from fluids. Without being able to remove such solids, the fluid density can increase, thereby increasing the hole pressure, and if such hole pressure exceeds the formation fracture pressure, fractures and fluid loss can result.

Various methods have been used to restore circulation of a drilling fluid when a lost circulation event has occurred, particularly the use of “lost circulation materials” that seal or block further loss of circulation. These materials may generally be classified into several categories: surface plugging, interstitial bridging, and/or combinations thereof. In addition to traditional lost circulation material (LCM) pills, crosslinkable or absorbing polymers, and cement or gunk squeezes have also been employed.

Accordingly, there exists a continuing need for developments for new LCM treatments that may be used during a lost circulation event so that circulation may be more readily resumed.

### SUMMARY OF INVENTION

In one aspect, embodiments disclosed herein relate to a slurry for treating a wellbore that includes a base fluid; at least one fibrous structure; and a plurality of calcium silicate particles.

In another aspect, embodiments disclosed herein are related to a slurry for treating a wellbore that includes a base fluid; at least one synthetic fibrous structure; at least one LCM material; and at least one weighting agent.

In another aspect, embodiments disclosed herein relate to a method of reducing loss of wellbore fluid in a wellbore to a formation that includes introducing into the wellbore an LCM slurry of a base fluid and a plurality of calcium silicate particles; and applying pressure to the slurry to decrease the fluid content of the slurry.

In yet another aspect, embodiments disclosed herein are related to a method of reducing loss of wellbore fluid in a wellbore to a formation that includes introducing into the wellbore an LCM slurry of a base fluid, at least one synthetic fibrous structure; at least one LCM material; and at least one weighting agent; and applying pressure to the slurry to decrease the fluid content of the slurry.

Other aspects and advantages of the invention will be apparent from the following description and the appended claims.

### DETAILED DESCRIPTION

Embodiments disclosed herein relate to novel wellbore fluid compositions. In particular, embodiments disclosed herein relate to slurry pills that may be defluidized (dewatered or deoiled) to leave behind a plug or seal as a lost circulation treatment. A primary component of the resulting plug or seal is silicate particles (pre-existing particles, e.g., wollastonite) and/or a fibrous structure. As used herein, the term “pill” is used to refer to a relatively small quantity (typically less than 200 bbl) of a special blend of wellbore fluid to accomplish a specific task that the regular wellbore fluid cannot perform. In one specific embodiment, the lost circulation pill may be used to plug a “thief zone,” which simply refers to a formation into which circulating fluids can be lost.

Lost circulation pills disclosed herein employ a slurry of a base fluid and a plurality of silicate particles, optionally with at least one fibrous structure, at least one weighting agent, and/or at least one bridging agent. In an alternative embodiment, lost circulation pills disclosed herein employ a slurry of a base fluid, an LCM material (including but not limited to the silicate particles), a weighting agent, and at least one synthetic fibrous structure, optionally with at least one natural fibrous structure, and/or at least one bridging agent. In yet other embodiments, the pills may include a number of other additives known to those of ordinary skill in the art, such as wetting agents, viscosifiers, surfactants, dispersants, interfacial tension reducers, pH buffers, mutual solvents, thinners, thinning agents, rheological additives and cleaning agents. In a particular embodiment, a fibrous structure may be added to an LCM pill in a thinner or dispersant that acts as a carrier for the fibrous structure, particularly if the LCM pill is at higher concentrations or if the pill generally has higher concentrations of the other components

What is significant, is upon placing the pill in the wellbore, the pill may be defluidized to lose a substantial portion of the base fluid to the formation such that the plurality of silicate particles and/or plurality of fibrous structures form a plug or seal having sufficient compressive and/or shear strength for the particular application, and which may increase the tensile strength of the rock formation.

For the embodiments that include weighting agents therein, the inventors of the present application have discovered that while high fluid loss LCM pills may lose strength upon addition of a weighting agent, incorporation of at least one synthetic fibrous structure may result in the pill increasing in strength (from the lower strength value observed without the addition of the fibrous structure). In particular, it is theorized that the inclusion of a weighting agent in an LCM pill may interfere with the stacking or imbrication of the LCM materials, to result in a lower strength plug or seal (than without the weighting agent). However, at least a portion of the strength may be restored by addition of the fibrous structure.

In accordance with some embodiments of the present disclosure, the “silicate particles” used in the LCM materials are “pre-existing” silicate particles, i.e., limited to particles existing or formed prior to formulation in a slurry and/or use in a wellbore operation, as compared to any particles that could be formed in situ (by reaction of chemical reactants or precursors) upon slurry formulation or during a wellbore operation. However, in other embodiments, an LCM material may include any silicate particles that could be formed in situ (by reaction of chemical reactants or precursors) upon slurry formulation or during a wellbore operation.

Calcium silicate may occur as CaSiO₃, CaSiO₄, Ca₂SiO₄, Ca₃Si₂O₇, Ca₃(Si₃O₉) and Ca₄(H₂Si₄O₁₃) with various percentages of water of crystallization, and may be either naturally (mined) or synthetically formed. Natural calcium silicate minerals are known by various names including larnite, hillebrandite, foshagite, afwillite, foshallasite, gjellebaekite, grammite, table spate, wollastonite, xonaltite, xonotlite, eaklite and calcium pectolith. While any of such calcium silicate forms may be used in the LCM materials of the present disclosure, in a particular embodiment, wollastonite or synthetically formed CaSiO₃ may be the preferred calcium silicate for use in some embodiments of the LCM pills of the present disclosure.

Wollastonite is a naturally occurring mineral, largely composed of calcium, silicon, and oxygen, from CaO and SiO₂, which primarily combine to form calcium metasilicate or CaSiO₃. While wollastonite primarily contains CaSiO₃, one skilled in the art would appreciate that there may be some trace metal ions present, such as iron, and manganese, and magnesium substituting for calcium. The crystal habits of wollastonite often include lamellar, radiating, compact and fibrous aggregates, as well as tabular crystals. If natural wollastonite is used, it may be desirable to purify or beneficiate the naturally formed ore, such as by magnetic and/or flotation separation means known in the art.

However, in other embodiments, the LCM material may include materials other than a plurality of silicate particles. The LCM materials that may be used in accordance with the present disclosure may include any material that may aid in forming a plug or seal to reduce fluid loss, and in particular embodiments, may include any LCM material that may form a defluidized plug or seal. For example, in one embodiment, the LCM material may include diatomaceous earth, calcium carbonate, aluminum silicate, or any other type of defluidizing LCM material known in the art. The LCM material may be added to the pill in an amount ranging from 0.5 ppb to 80 ppb in some embodiments; however, more or less may be desired depending on the particular application.

The particle size of the various LCM materials (pre-existing silicate particles or other LCM materials) may also be selected depending on the particular application, in particular on the level of fluid loss, formation type, and/or the size of fractures predicted for a given formation. The LCM particles may range in size from nano-scale to a macro-scale, for example, in a particular embodiment from 100 nanometers to 3000 microns, and preferably 25 microns to 1500 microns. The size may also depend on the other particles selected for use in the LCM pill. Typically, the fractures that may be plugged or filled with a particulate-based treatment may have a fracture width at the mouth in the range 0.1 to 5 mm. However, the fracture width may be dependent, amongst other factors, upon the strength (stiffness) of the formation rock and the extent to which the pressure in the wellbore is increased to above initial fracture pressure of the formation during the fracture induction (in other words, the fracture width is dependent on the pressure difference between the drilling mud and the initial fracture pressure of the formation during the fracture induction step). In some embodiments, the LCM materials may have a planar or sheet-like structure, with an aspect ratio of greater than about 4. Such structure may result in greater imbrication or stacking of the particles to form the plug or seal.

The amount of LCM materials (silicate particles or other LCM materials) present in a slurry may depend on the fluid loss levels, the anticipated fractures, the density limits for the pill in a given wellbore and/or pumping limitations, etc. For example, generally, an upper limit on most wellbore applications would be 150 pounds per barrel, above which point the slurry is too thick to adequately mix. In particular embodiments, the amount of LCM material in a slurry may range from 10 ppb to 50 ppb; however, more or less may be used in other embodiments.

As mentioned above, some embodiments may include at least one fibrous structure to optionally be used with the silicate or wollastonite particles to aid in suspension and viscosification of the slurry, but may also provide additional compressive strength to the resulting plug or seal. However, other embodiments may use other LCM materials, where the addition of the fibrous structure (synthetic, in particular) may restore at least a portion of the strength loss due to the incorporation of a weighting agent. As used herein, the term “fibrous structure” refers to an additive that has an elongated structure. The fibrous structure may be inert (does not react with) with respect to the base fluid and the silicate particles or other LCM materials used.

Various embodiments of the present disclosure may use a fibrous structure that has an elongated structure, which may be spun into filaments or used as a component of a composite material such as paper. In a particular embodiment, the fibers may range in length from greater than 3 mm to less than 20 mm. While some embodiments may use a synthetic fibrous structure, other embodiments may include either a naturally occurring fibrous (such as cellulose) material, and/or a synthetic (such as polyethylene, or polypropylene) fibrous material.

Synthetic fibers may include, for example, polyester, acrylic, polyamide, polyolefins, polyaramid, polyurethane, vinyl polymers, glass fibers, carbon fibers, regenerated cellulose (rayon), and blends thereof. Vinyl polymers may include, for example, polyvinyl alcohol. Polyesters may include, for example, polyethylene terephthalate, polytriphenylene terephthalate, polybutylene terephthalate, polylatic acid, and combinations thereof. Polyamides may include, for example, nylon 6, nylon 6,6, and combinations thereof. Polyolefins may include, for example, propylene based homopolymers, copolymers, and multi-block interpolymers, and ethylene based homopolymers, copolymers, and multi-block interpolymers, and combinations thereof. The fibrous structure may be added to the pill in an amount ranging from 0.5 ppb to 10 ppb in some embodiments; however, more or less may be desired depending on the particular application.

A natural fibrous structure may optionally be used with the LCM materials (including silicate particles or other LCM materials) to aid in suspension and viscosification of the slurry, as well as provide additional compressive strength to the resulting plug or seal. As used herein, the term “natural fibrous structure” refers to an additive formed from a naturally occurring material that has an elongated structure, which may be spun into filaments or used as a component of a composite material such as paper. Similar to the synthetic fibrous structure described above, the natural fibrous structure may be inert (does not react with) with respect to the base fluid and to the LCM materials. When included, natural fibers may be present in an amount up to 50 percent by weight of the pill.

Natural fibers generally include vegetable fibers, wood fibers, animal fibers, and mineral fibers. In particular, the natural fibers components used in conjunction with wollastonite include cellulose, a polysaccharide containing up to thousands of glucose units. Cellulose from wood pulp has typical chain lengths between 300 and 1700 units, whereas cotton and other plant fibers as well as bacterial celluloses have chain lengths ranging from 800 to 10,000 units. No limit on the type of natural fibers (or cellulose in particular) that may be used in the pills of the present disclosure is intended; however, in a particular embodiment, cellulose fibers may be either virgin or recycled, extracted from a wide range of plant species such as cotton, straw, flax, wood, etc. Additionally, it is also within the scope of the present disclosure that such cellulosic materials may be combined, pressed together to form larger sheets. Some commercial sources of cellulose (paper) may optionally be coated to render the sheets hydrophilic or hydrophobic; however, such coatings are optional. The sheets may then be finely divided for use in the slurries disclosed herein.

Further, as mentioned above, the pills of the present disclosure may optionally include at least one weighting agent to provide the desired weight to the pills. As is known in the art, control of density may be desired to balance pressures in the well and prevent a blowout. To prevent a blowout, the fluid in the well may have a density effective to provide a greater pressure than that exerted from the formation into the well. However, densities should not be too high or else they may cause further lost circulation. Thus, it is often desirable to modify the density of an LCM pill with weighting agents to balance the pressure requirements of the well. Weighting agents may be selected from one or more of the materials including, for example, barium sulphate (barite), calcium carbonate (calcite), dolomite, ilmenite, hematite or other iron ores, olivine, siderite, manganese oxide, and strontium sulfate. Additionally, it is also within the scope of the present disclosure that the fluid may also be weighted up using salts (either in a water- or oil-based pill) such as those described above with respect to brine types. One having ordinary skill in the art would recognize that selection of a particular material may depend largely on the density of the material as typically, the lowest wellbore fluid viscosity at any particular density is obtained by using the highest density particles. Weighting agents may be added to the pill in an amount such that the final density may range from 6.5 pounds per gallon (ppg) to 20 ppg in some embodiments.

Thus, according to one embodiment of the present disclosure, an LCM pill may include a base fluid and a plurality of pre-existing silicate particles (such as wollastonite). Optionally components may include at least one natural and/or synthetic fibrous structure, at least one weighting agent, and/or at least one bridging agent. When a fibrous structure is used in combination with the silicate/wollastonite particles, the ratio of silicate particles to fiber may range from 50:50 at the low end to 95:5 at the upper end depending on the number and type of fiber(s) employed. In various embodiments, the pill may include up to 20 percent by weight silicate/wollastonite particles, up to 15 percent by weight fibrous structure (either natural fibrous structure and/or synthetic fibrous structure), and a balance base fluid for pill densities up to 20 ppg. Further, one skilled in the art would appreciate after reading the teachings contained in the present disclosure that the amount of fibrous structure (natural and/or synthetic) added to the pill may depend on the amount of wollastonite, the presence (and amount) of weighting agent in the pill, the total amount of solids present, and the length of the fibers and may be adjusted accordingly (upwards or downwards) so long as the fluid is mixable and pumpable.

In accordance with another embodiment of the present disclosure, an LCM pill may include at least one LCM material (including but not limited to silicate/wollastonite) and at least one synthetic fibrous structure in combination with a base fluid and weighting agent. The ratio of LCM materials to fiber may range from 50:50 at the low end to 95:5 at the upper end depending on the number and type of fiber(s) employed. Additionally, in a particular embodiment, the pill may include 10 ppb to 150 ppb LCM materials, weighting agent in amount such that the final density may range from 6.5 pounds per gallon (ppg) to 20 ppg, up to 10 percent by weight synthetic fibrous structure (up to 5 or 3 weight percent by weight synthetic fiber in more particular embodiments), optionally a natural fibrous structure at up to 15 percent by weight, and a balance base fluid for pill densities up to 20 ppg. Further, one skilled in the art would appreciate after reading the teachings contained in the present disclosure that the amount of synthetic fibrous structure added to the pill may depend on the amount of LCM materials, the type of LCM material, the amount of weighting agent in the pill, and the length of the synthetic fibers and may be adjusted accordingly (upwards or downwards) so long as the fluid is mixable and pumpable.

However, according to another embodiment of the present disclosure, an LCM pill may include a slurry of a base fluid, an LCM material (including but not limited to the pre-existing silicate particles), a weighting agent, and at least one synthetic fibrous structure. Optional components may include at least one natural fibrous structure, and/or at least one bridging agent.

The base fluid may be an aqueous fluid or an oleaginous fluid. The aqueous fluid may include at least one of fresh water, sea water, brine, mixtures of water and water-soluble organic compounds and mixtures thereof. For example, the aqueous fluid may be formulated with mixtures of desired salts in fresh water. Such salts may include, but are not limited to alkali metal chlorides, hydroxides, or carboxylates, for example. In various embodiments of the drilling fluid disclosed herein, the brine may include seawater, aqueous solutions wherein the salt concentration is less than that of sea water, or aqueous solutions wherein the salt concentration is greater than that of sea water. Salts that may be found in seawater include, but are not limited to, sodium, calcium, aluminum, magnesium, potassium, strontium, and lithium, salts of chlorides, bromides, carbonates, iodides, chlorates, bromates, formates, nitrates, oxides, phosphates, sulfates, silicates, and fluorides. Salts that may be incorporated in a brine include any one or more of those present in natural seawater or any other organic or inorganic dissolved salts. Additionally, brines that may be used in the pills disclosed herein may be natural or synthetic, with synthetic brines tending to be much simpler in constitution. In one embodiment, the density of the pill may be controlled by increasing the salt concentration in the brine (up to saturation). In a particular embodiment, a brine may include halide or carboxylate salts of mono- or divalent cations of metals, such as cesium, potassium, calcium, zinc, and/or sodium.

The oleaginous fluid may be a liquid, more preferably a natural or synthetic oil, and more preferably the oleaginous fluid is selected from the group including diesel oil; mineral oil; a synthetic oil, such as hydrogenated and unhydrogenated olefins including polyalpha olefins, linear and branch olefins and the like, polydiorganosiloxanes, siloxanes, or organosiloxanes, esters of fatty acids, specifically straight chain, branched and cyclical alkyl ethers of fatty acids; similar compounds known to one of skill in the art; and mixtures thereof. Selection between an aqueous fluid and an oleaginous fluid may depend, for example, on the type of drilling fluid being used in the well at the time of the lost circulation event. Use of the same fluid type may reduce contamination and allow drilling to continue upon plugging of the formation fractures/fissures, etc.

In addition to the silicate/wollastonite particles (or other LCM materials), fibrous structures, and/or weighting agents, it is also within the scope of the present disclosure that bridging agents may also be incorporated into the LCM pills. Particulate-based treatments may include use of particles frequently referred to in the art as bridging materials. For example, such bridging materials may include at least one substantially crush resistant particulate solid such that the bridging material props open and bridges or plugs the fractures (cracks and fissures) that are induced in the wall of the wellbore. As used herein, “crush resistant” refers to a bridging material is physically strong enough to resist the closure stresses exerted on the fracture bridge. Examples of bridging materials suitable for use in the present disclosure include graphite, calcium carbonate (preferably, marble), dolomite (MgCO₃.CaCO₃), celluloses, micas, proppant materials such as sands or ceramic particles and combinations thereof. Such particles may range in size from 25 microns to 1500 microns. Selection of size may depend on the level of fluid loss, the fracture width, the formation type, etc.

One skilled in the art would appreciate that depending on components present in the fluid, the pH of the fluid may change. In particular embodiments of the present disclosure, the pH of the LCM treatment fluid may be less than about 10, and between about 7.5 and 8.5 in other embodiments. However, in other embodiments, a greater pH may be desired, and may be achieved by including an alkaline material such as lime to the pill.

As mentioned above, the components disclosed herein may be combined to form a wellbore fluid, and an LCM slurry in particular. Upon introduction into the wellbore (by spotting a slug or pill of the LCM slurry adjacent a permeable formation), the slurry may be defluidized. Defluidization of the slurry may deposit a plug or seal of LCM materials (silicate/wollastonite particles or other LCM materials as well as other optional particles) optionally with a supporting fibrous structure on the wellbore wall, reducing or blocking the efflux of fluid into the formation. Upon sealing the permeable formation, circulation of the drilling fluid may continue and a traditional filter cake may be formed on top of the LCM filter cake to better seal the wellbore walls.

Spotting an LCM pill adjacent a permeable formation may be accomplished by methods known in the art. For example, the “thief” or permeable formation will often be at or near the bottom of the wellbore because when the permeable formation is encountered the formation will immediately begin to take drilling fluid and the loss of drilling fluid will increase as the permeable formation is penetrated eventually resulting in a lost circulation condition. In such situations, the LCM slurry may be spotted adjacent the permeable formation by pumping a slug or pill of the slurry down and out of the drill pipe as is known in the art. It may be, however, that the permeable formation is at a point farther up in the wellbore, which may result, for example, from failure of a previous seal. In such cases, the drill pipe may be raised as is known in the art so that the pill or slug of the LCM slurry may be deposited adjacent the permeable formation. The volume of the slug of LCM pill that is spotted adjacent the permeable formation may range from less than that of the open hole to more than double that of the open hole.

Defluidization of the LCM slurry may be accomplished either by hydrostatic pressure or by exerting a low squeeze pressure as is known in the art. Hydrostatic pressure will complete the seal; however, a low squeeze pressure may be desirable because incipient fractures or other areas of high permeability can be thereby opened and plugged immediately, thus reinforcing the zone and reducing or avoiding the possibility of later losses. After the defluidization is completed, the drilling fluid may be recirculated through the wellbore to deposit a filtercake on the formation seal, and drilling may be resumed. Injection of the particles into the formation may be achieved by an overbalance pressure (i.e., an overbalance pressure greater than the formation pressure). While in particular embodiments, the injection pressure may range from 100 to 400 psi, any overbalance pressure level, including less than 100 psi or greater than 400 psi may alternatively be used. The selection of the injection pressure may simply affect the level of injection of the pill into the formation.

In some instances, it may be necessary to use more than one LCM pill. Such need may arise when the first pill was insufficient to plug the fissures and thief zone or was placed incorrectly. Further, in some instances, the first pill may have sufficiently plugged the first lost circulation zone, but a second (or more) lost circulation zone also exists needed treatment.

It is also within the scope of the present disclosure that one or more spacer pills may be used in conjunction with the pills of the present disclosure. A spacer is generally characterized as a thickened composition that functions primarily as a fluid piston in displacing fluids present in the wellbore and/or separating two fluids from each other.

### EXAMPLES

The following example is provided to further illustrate the application and the use of the methods and compositions of the present disclosure.

### Example 1

Slurries of LCM materials in water were formulated as shown below in Table 1. The slurries were de-fluidized across an aloxite disc in an inverted permeability plugging apparatus. Defluidizing times and relative strength values (in defluidized state) under pressures ranging from 100-400 psi were measured, the results of which are also shown in Table 1. Penetrometer strength was measured by driving a 4 mm diameter cylindrical, flat-faced probe of a Brookfield QTS-25 Texture Analysis Instrument into a defluidized sample at a constant speed of 5 mm per minute. FORM-A-SQUEEZE® is a lost circulation pill available from the Alpine Specialty Chemicals division of M-I SWACO (Houston, Tex.), and INTERFIBE® FTP is a cellulose fiber product available from J. Rettenmaier USA LP (Schoolcraft, MI).

TABLE 1

| | | | Penetrom- |
|---|---|---|---|
| | | Defluidizing | eter |
| | | Time | Strength |
| Sample | Conc. (ppb) | (min:sec) | (psi) |
| Sample 1 | 10 ppb INTERFIBE ® FTP & | 1:03 | >12,000 |
| | 30 ppb wollastonite in water | | |
| Sample 2 | 10 ppb INTERFIBE ® FTP & | 1:06 | >12,000 |
| | 30 ppb wollastonite in LVT-200 | | |
| Sample 3 | 5 ppb INTERFIBE ® FTP & | 1:05 | >12,000 |
| | 35 ppb wollastonite in water | | |
| Sample 4 | 5 ppb INTERFIBE ® FTP & | 1:10 | >12,000 |
| | 15 ppb wollastonite in water | | |
| Sample 5 | 10 ppb paper mache & | 1:34 | >12,000 |
| | 30 ppb wollastonite in water | | |
| Sample 6 | 10 ppb paper mache & | 1:07 | >12,000 |
| | 30 ppb wollastonite in LVT-200 | | |
| Comparative | 80 ppb FORM-A-SQUEEZE ® | 2:42 | 2217 |
| Sample 1 | in water | | |

As seen from Table 1, Samples 1-6 all defluidized faster than the comparative sample and possessed a penetrometer strength of significantly greater than the comparative sample. Further, in various embodiments (depending on the relative amounts of the pill components), the plugs or seals of the present disclosure may have a penetrometer strength (measured on the QTS-25 Texture Analysis Instrument using a 4 mm cylindrical, flat-faced probe into a defluidized pill sample at 5 mm/min) of upwards of 3,000 psi and upwards of 10,000 psi, 12,000, or more in other embodiments.

### Example 2

Slurries of LCM materials in water were formulated as shown below in Table 2. EMI-1810 is a LCM pill of wollastonite and a cellulosic material in water, available from M-I LLC (Houston, Tex.). EMI-1820 is a LCM pill of wollastonite, a cellulosic material, and polyvinyl alcohol fibers in water, also available from M-I LLC. EZ SQUEEZE® is a LCM pill available from Turbo-Chem International, Inc. (Scott, La.). Super Sweep is a polypropylene fiber from FORTA Corporation (Grove City, Pa.). RSC 15 is a polyvinyl alcohol fiber, supplied by New NYCON Materials (Westerly, R.I.). AC 06 and AR 12 are fiberglass fibers, supplied by New NYCON Materials (Westerly, R.I.). AGM 94 is a carbon fiber, supplied by Asbury Carbons (Asbury, N.J.). AS1925 is a carbon fiber, supplied by Hexcel Corporation (Salt Lake City, Utah). PA6 and PU6 1 are carbon fibers, each supplied by Grafil Inc. (Sacramento, Calif.). FORM-A-SQUEEZE® is a LCM pill available from M-I LLC. VPB102 is a polyvinyl alcohol fibers, produced by Kuraway (Okayama, Japan).

TABLE 2

| | | Shear Strength |
|---|---|---|
| Sample | Slurries | (psi) |
| Sample 7 | 40 ppb EMI-1810 | 2106 |
| Sample 8 | Sample 7 at 12 ppg | 296 |
| Sample 9 | Sample 7 at 12.5 ppg | 251 |
| Sample 10 | Sample 7 at 16 ppg | 67 |
| Sample 11 | Sample 8 + 1 ppb Super Sweep − ½″ | 660 |
| Sample 12 | Sample 8 + 2 ppb Super Sweep − ½″ | 736 |
| Sample 13 | Sample 8 + 2 ppb RSC 15 − ⅓″ | 921 |
| Sample 14 | Sample 8 + 6 ppb AC 06 − ½″ | 442 |
| Sample 15 | Sample 8 + 4 ppb AR 12 − ½″ | 793 |
| Sample 16 | Sample 8 + 1 ppb AGM 94 − ¼″ | 651 |
| Sample 17 | Sample 8 + 1 ppb AGM 94 − ⅛″ | 623 |
| Sample 18 | Sample 8 + 2 ppb AGM 62 − ¼″ | 679 |
| Sample 19 | Sample 8 + 4 ppb AS1925 − ¼″ | 702 |
| Sample 20 | Sample 8 + 6 ppb AS1925 − ¼″ | 1029 |
| Sample 21 | Sample 9 + 6 ppb AS1925 − ¼″ | 918 |
| Sample 22 | Sample 9 + 8 ppb AS1925 − ¼″ | 971 |
| Sample 23 | Sample 8 + 6 ppb PA6 2 − ¼″ | 310 |
| Sample 24 | Sample 8 + 10 ppb PA6 2 − ¼″ | 513 |
| Sample 25 | Sample 8 + 6 ppb PU6 1 − ¼″ | 361 |
| Sample 26 | Sample 8 + 10 ppb PU6 1 − ¼″ | 600 |
| Sample 27 | 40 ppb EMI-1820 (Unweighted) | 2692 |
| Sample 28 | Sample 27 at 12.5 ppg | 965 |
| Sample 29 | Sample 27 at 16 ppg | 556 |
| Sample 30 | 40 ppb EZ SQUEEZE ® (Unweighted) | 810 |
| Sample 31 | Sample 30 at 12.5 ppg | 271 |
| Sample 32 | Sample 30 at 16 ppg | 219 |
| Sample 33 | 80 ppb FORM-A-SQUEEZE ® | 60 |
| | (Unweighted) | |
| Sample 34 | Sample 33 at 12.5 ppg | 50 |
| Sample 35 | Sample 33 at 16 ppg | 32 |
| Sample 36 | Sample 33 + 2 ppb RSC15 − ⅓″ | 570 |
| Sample 37 | Sample 33 + 2 ppb VPB-102 − 5 mm | 365 |
| Sample 38 | Sample 34 + 2 ppb VPB-102 − 5 mm | 263 |

A standard Pore Plugging Test (PPT) apparatus is used to create a cake from the sample slurries. Standard cake preparation conditions include:
Volume of pill—as required to produce cake thickness of about 20 mm
20 micron aloxite disc for substrate (Part No. 170-51), pre-soaked overnight in the base fluid
Squeeze pressure: apply 400 psi differential for a 10 minute period
Measure the fluid loss (usually very high)
Extract the cake and measure its thickness
Measure the cake strength straight away (do not allow it to dry out)

When forming the cake with high fluid loss mixtures, all of the fluid will quickly run through the cake when the 400 psi pressure is applied. The time for all fluid to pass through should be recorded. To maintain the squeeze pressure across the cake, the PPT piston is allowed to push up against the cake and is kept there under pressure for 10 minutes, typically. This simulates the mud overbalance pressure in the field. The receiver is constantly draining during the test.

The formed defluidized LCM cakes were tested by using a push-out test methodology developed by BP Sunbury, UK to measure the strength of the cake. The test measures shear strength by pressing a pellet out of the cake. Once the cakes are formed, the strength is measured to reduce any effect that drying may have on the cake properties. The formed cake is placed into a close-fitting sample holder (cylinder), which has a hole at the bottom which is ½ the cake diameter (i.e. approx 1″ diameter) through which a plug can be punched out. Force is applied via the brass piston, using a “Carver Press,” and a pellet is forced out through the hole. The cell is raised up and supported on each edge, allowing the pellet to be free to come out through the hole. The force is applied evenly at 1 pump stroke per 10 second interval. The maximum force in pounds from the gauge is recorded. The recorded pressure is converted to shear strength as follows:

S=(F)/A and Failure area (A)=π*d*t,

Where d is the plug diameter (in), t is the cake thickness (in), A is the failure area (in²), F is the maximum recorded force (lbf), and S is the shear strength (psi).

As shown by the measured shear strength values listed in Table 2, an LCM pill having a high initial shear strength value may lose its strength upon addition of a weighting agent. However, at least a portion of the strength may be retained by the inclusion of a synthetic fiber structure in the pill contents.

Embodiments of the present disclosure may provide for at least one of the following advantages. The present inventors have advantageously discovered that by using wollastonite or other silicate particles, a lost circulation fluid may be created that may be particularly useful in high fluid loss zones (as well as in low fluid loss zones). Without being bound by any particular mechanism, the present inventors believe that disclosed embodiments operate due to a sheeting or leafing of particles across the fissures and fractures. Use of the pills of the present disclosure may allow for the formation of a plug or seal of a permeable formation that has a high compressive strength, which allows for greater pressures to be used without risk of experiencing further losses to the sealed lost circulation zone. Additionally, not only does the pill defluidize faster than previously cited LCM pills, it also may de-water and de-oil effectively, allowing the pill to be applied with both water-based and oil-based drilling fluid systems.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed:

1. A slurry for treating a wellbore, comprising:
a base fluid;
at least one fibrous structure; and
a plurality of calcium silicate particles.

2. The slurry of claim 1, wherein the fibrous structure comprises at least one of cellulosic fibers or synthetic fibers.

3. The slurry of claim 1, wherein the calcium silicate comprises wollastonite.

4. The slurry of claim 1, wherein the base fluid comprises an oleaginous fluid or a non-oleaginous fluid.

5. The slurry of claim 1, wherein the slurry further comprises at least one bridging agent or weighting agent.

6. A slurry for treating a wellbore, comprising:
a base fluid;
at least one synthetic fibrous structure;
at least one LCM material; and
at least one weighting agent.

7. The slurry of claim 6, wherein slurry further comprises at least one natural fiber.

8. The slurry of claim 6, wherein the LCM material comprises wollastonite.

9. The slurry of claim 6, wherein the base fluid comprises an oleaginous fluid or a non-oleaginous fluid.

10. The slurry of claim 6, wherein the at least one synthetic fibrous structure comprises at least one of polyester, acrylic, polyamide, polyolefins, polyaramid, polyurethane, vinyl polymers, glass fibers, carbon fibers, regenerated cellulose (rayon), or blends thereof.

11. The slurry of claim 10, wherein the at least one synthetic fibrous structure comprises polyvinyl alcohol.

12. A method of reducing loss of wellbore fluid in a wellbore to a formation, comprising:
introducing into the wellbore an LCM slurry of a base fluid and a plurality of calcium silicate particles; and
applying pressure to the slurry to decrease the fluid content of the slurry.

13. The method of claim 12, wherein the calcium silicate comprises wollastonite.

14. The method of claim 12, wherein the slurry further comprises at least one fibrous structure.

15. The method of claim 14, wherein the fibrous structure comprises at least one of cellulosic fibers or synthetic fibers.

16. The method of claim 12, wherein the slurry comprises at least one weighting agent.

17. The method of claim 12, further comprising:
introducing at least one spacer pill before the LCM slurry is introduced into the wellbore.

18. The method of claim 12, further comprising:
introducing at least one spacer pill after the LCM slurry is introduced into the wellbore.

19. The method of claim 12, further comprising:
introducing into the wellbore a second LCM slurry of a base fluid and a plurality of calcium silicate particles; and
applying pressure to the second slurry to decrease the fluid content of the second slurry.

20. A method of reducing loss of wellbore fluid in a wellbore to a formation, comprising:
introducing into the wellbore an LCM slurry of a base fluid, at least one synthetic fibrous structure; at least one LCM material; and at least one weighting agent; and
applying pressure to the slurry to decrease the fluid content of the slurry.

21. The method of claim 20, wherein the LCM material comprises wollastonite.

22. The method of claim 20, wherein the slurry further comprises at least one natural fibrous structure.

23. The method of claim 20, wherein the at least one synthetic fibrous structure comprises at least one of polyester, acrylic, polyamide, polyolefins, polyaramid, polyurethane, vinyl polymers, glass fibers, carbon fibers, regenerated cellulose (rayon), or blends thereof.

24. The method of claim 23, wherein the at least one synthetic fibrous structure comprises polyvinyl alcohol.

25. The method of claim 23, further comprising:
introducing at least one spacer pill before the LCM slurry is introduced into the wellbore.

26. The method of claim 23, further comprising:
introducing at least one spacer pill after the LCM slurry is introduced into the wellbore.

27. The method of claim 23, further comprising:
introducing into the wellbore a second LCM slurry of a base fluid, at least one synthetic fibrous structure; at least one LCM material; and at least one weighting agent; and
applying pressure to the second slurry to decrease the fluid content of the second slurry.
